(19) United States
(12) Patent Application Publication
(10) Pub. No.: US 2010/0305843 A1
(43) Pub. Date: Dec. 2, 2010

(54) NAVIGATION INDICATOR

(75) Inventors: Qifeng Yan, Espoo (FI); Antti Paavo Tapani Kainulainen, Espoo (FI); Kimmo Heikki Juhana Kalliola, Helsinki (FI)

Correspondence Address: Perman & Green, LLP, 99 Hawley Lane, Stratford, CT, 06614, US

(73) Assignee: Nokia Corporation, Espoo (FI)

(21) Appl. No.: 12/474,351

(22) Filed: May 29, 2009

(51) Int. Cl. G01C 21/00

(52) U.S. Cl. 701/201

(57) ABSTRACT

A method, apparatus, user interface and computer program product for identifying location information for a target object includes coding the identified location information onto a graphical indicator; and, presenting the graphical indicator on a user interface of the mobile device, wherein the indicator provides direction, distance, obstacle and signal information corresponding to the target object to a user of the mobile device.

### BACKGROUND

1. Field

The aspects of the disclosed embodiments generally relate to user interfaces and in particular to information visualization for a local positioning system.

2. Brief Description of Related Developments

When users are looking for a location without a map, it can be difficult to find the target location in an efficient manner. Generally, certain types of information will be required to find the location. This information can include, for example, the distance from the present location to the target location, the direction from the present location, whether there are any obstacles in-between, or even how certain the direction indications are. Where directions are being provided over a mobile communication device, signal quality can sometimes affect the received or desired information.

Given the limited attention span of some users, providing directional information in separate parts can make it difficult to effectively follow the directional information. Furthermore, certain levels of directional detail may not be relevant, desired or needed when searching for a location. For example, some directional or navigation programs and devices will provide information related to a relatively precise distance to the target location, such as “34.25 meters.” This level of detail may not be relevant to a user when trying to find a house or place of business, for example. Rather, the user may only be interested in knowing that they are get closer to, or are at the target location.

Current object finding products tend to rely on audio and visual signals that are emitted from tags attached to the objects and received by the searching device. In some cases, a distance to the tag can also be presented. Other devices can provide different information categories that are separately displayed on the user interface. Several objects or tags can be moving on the screen at the same time, but generally it is only possible to focus on one object at a time.

It would be advantageous to be able to present directional information in a more simplified and combined manner on a user interface. Accordingly, it would be desirable to provide a system that addresses at least some of the problems identified above.

### SUMMARY

The aspects of the disclosed embodiments are directed to at least a method, apparatus, user interface and computer program product. In one embodiment the method includes identifying location information for a target object; coding the identified location information onto a graphical indicator; and presenting the graphical indicator on a user interface of the mobile device, wherein the indicator provides direction, distance, obstacle and signal information (for example, signal strength and quality) corresponding to the target object to a user of the mobile device.

### BRIEF DESCRIPTION OF THE DRAWINGS

The foregoing aspects and other features of the embodiments are explained in the following description, taken in connection with the accompanying drawings, wherein:

FIG. 1 is a block diagram of a system incorporating aspects of the disclosed embodiments;

FIG. 2A-2D illustrate aspects exemplary indicators including aspects of the disclosed embodiments;

FIG. 3 illustrates example of exemplary screen shots of a user interface incorporating aspects of the disclosed embodiments;

FIG. 4A-4B are illustrations of exemplary devices that can be used to practice aspects of the disclosed embodiments;

FIG. 5 illustrates a block diagram of an exemplary system incorporating features that may be used to practice aspects of the disclosed embodiments; and

FIG. 6 is a block diagram illustrating the general architecture of an exemplary system in which the devices of FIGS. 4A and 4B may be used.

### DETAILED DESCRIPTION OF THE EMBODIMENT(S)

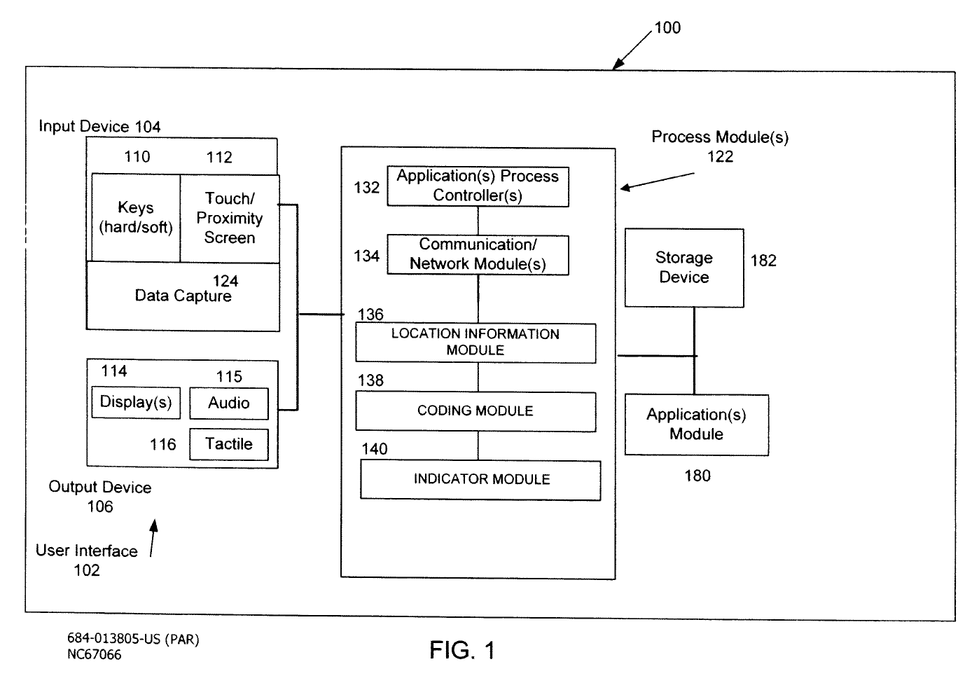

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments generally provide for combining or coding directional or “locating” information into or onto a single graphic indicator or icon on a user interface. When looking for a target object, such as for example a person or a place, certain types of directional information can be presented or provided in order to find or locate the target object. The term “target object” will be used herein to generally describe anything to be located, including, but not limited to, an article, item, service, service provider (such as emergency services), person, geographic position or place. In alternate embodiments, the target object comprises any suitable target for which location information and data can be ascertained. Examples of the types of information that might be used can include, but are not limited to, direction, distance, signal quality, and obstacles. In alternate embodiments, any suitable information can be used for locating or finding a target object. By coding all the “locating” information into a single, property changing, graphical indicator, the user can easily and efficiently interpret the information that is being presented. For example, the distance, direction, signal quality and obstacle information can be coded into a single graphic, such as for example, an arrow on the user interface. This can eliminate the need to provide a map or other such positioning or locating solution, and provides the advantage of being able to combine all of the locating data or information into a single indicator.

Generally, the system 100 of FIG. 1 includes at least one user interface 106, process modules 122, applications module 180, and storage devices 182. In alternate embodiments, the system 100 can include other suitable systems, devices and components that allow for coding locating information into a single, property changing, graphical indicator. The components described herein are merely exemplary and are not intended to encompass all components that can be included in the system 100. The devices described with respect to the system 100 also include one or more processors or computer program products to execute the processes, methods, sequences, algorithms and instructions described herein.

The user interface 106 generally comprises one or more input devices 104 and output devices 106. The input device(s) 104 are generally configured to allow the input of data, instructions, information gestures and commands to the system 100. The input devices 104 can include devices such as, for example, keys or keypad 210, touch sensitive area or screen 112 and other data capture device(s) 124. In one embodiment, the keypad 110 can be a soft key or other such adaptive or dynamic device of a touch screen. The input device 104 can also be configured to receive input commands remotely or from another device that is not local to the system 100. The data capture device(s) can include camera devices (not shown) or other such image capturing system(s). In alternate embodiments the input device 104 can comprise any suitable device(s) or means that allows or provides for the input and capture of data, information and/or instructions to a device, as described herein.

The output device(s) 106 are generally configured to allow information and data to be presented to the user via the user interface 102 of the system 100 and can include one or more devices such as, for example, a display 114, audio device 115 or tactile output device 116. In one embodiment, the output device 106 can also be configured to transmit information to another device, which can be remote from the system 100. While the input device 104 and output device 106 are shown as separate devices, in one embodiment, the input device 104 and output device 106 can comprise a single device, such as for example a touch screen device, and be part of and form, the user interface 102. For example, in one embodiment where the user interface 102 includes a touch screen device, the touch sensitive screen or area 112 can also provide and display information, such as keypad or keypad elements and/or character outputs in the touch sensitive area of the display 114. While certain devices are shown in FIG. 1, the scope of the disclosed embodiments is not limited by any one or more of these devices, and an exemplary embodiment can include, or exclude, one or more devices.

The process module 122 is generally configured to execute the processes and methods of the disclosed embodiments. As described herein, the process module 122 is generally configured to identify or determine the positioning and locating information of the object desired to be located, and then code the location information into a single, property changing, graphical indicator. In one embodiment, the process module 122 includes a location information module 136, a coding module 138, and an indicator module 140. In alternate embodiments, the process module 122 can include any suitable function or application modules for identifying, determining and coding location information into a single, property changing, graphical indicator as is further described herein.

In one embodiment, the location information module 136 is configured to identify or determine the position or positioning of location of a target object, generally referred to as “location information” herein. For example, the location information module 136 can retrieve or receive the location information from another server or service. Alternatively, the location information module 136 is configured to determine the location information. In one embodiment, if the distance to the target object is far, the location information can be obtained from another user's phone nearby to the target object, through a server connection, for example. Generally, the positioning or location information or data will be determined relative to a user's device or the system 100, such as for example, a mobile communication device. Any suitable system or application can be used to determine the location data, such as for including, a global positioning system (“GPS”), an object tracking application or a tag locating application. In one embodiment, the location information module 136 can include or be able to access a compass or compass application. The compass can provide precise directional information to the target object.

The location information can include for example, but is not limited to, a distance to the target, the direction to the target, obstacles along a path to the target, and a signal quality of any tracking devices associated with the target. In alternate embodiments, any suitable information can be used for determining or establishing a location of a target relative to the system 100. For example, in one embodiment, the geographical coordinates are obtained and then used by the system 100, or an external map or routing service, to provide the location information to the location information module 136. The location information is provided from the location information module 136 to the coding module 138 in a suitable format. The coding module 138 is generally configured to code the location information into a graphical indicator that has one or more variable or changing properties. The one or more properties of the graphical indicator are configured to change or vary with a corresponding one of the location information. The association of the location information to the properties of the indicator are generally pre-determined or pre-set so that they are easily understood or interpreted by the user.

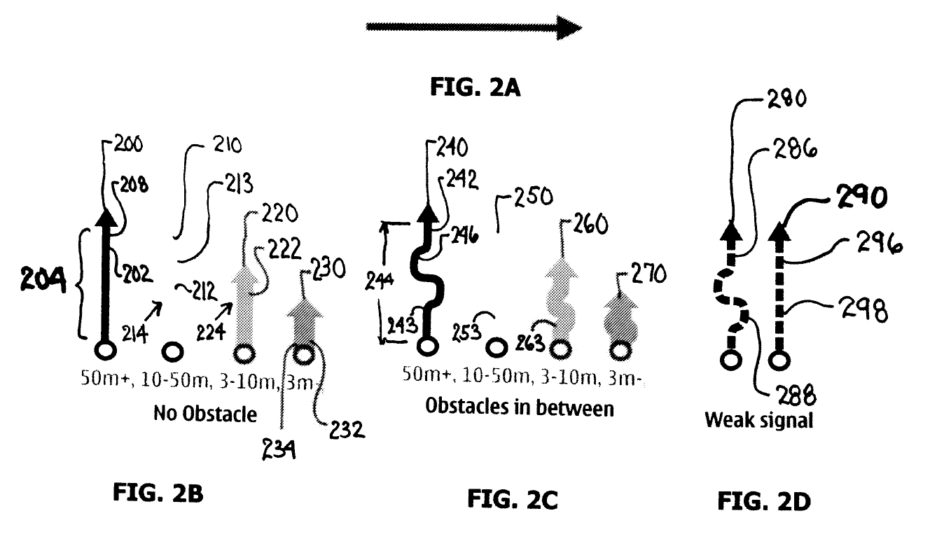

Generally, the graphical indicator is any indicator that variable properties, such as for example, shape, size, length and color. In one embodiment, the graphical indicator is an arrow, such as arrow 200 shown in FIG. 2A. The arrow 200 has one or more properties that can be varied, such as for example, shape, length, width, weight, type, font, style, direction, curvature and color, for example. In alternate embodiments, any suitable character or indicator that has properties that can be varied can be used, other than including an arrow. The coding module 138 is configured to associate the location information determined by the location information module 136 with predetermined properties of the graphical indicator. For example, in one embodiment, the location information to be coded includes the distance, direction, signal quality and obstacle information. Each one of these will be coded to a variable property of the graphical indicator.

In one embodiment, the graphical indicator and the variable properties of the graphical indicator are provided by the indicator module 140. The indicator module 140 is generally configured to provide for the selection of and identify a selected indicator to the coding module 138. The indicator module 140 can also identify those properties of the selected or assigned indicator that can be varied and allow for the assignment of categories of location information to the indicator properties. In one embodiment, the variable properties of the indicator will be pre-assigned to correspond to certain location information. For example, in one embodiment, a length of the indicator can generally correspond to a distance to the target object. A different length indicates a different distance. A longer indicator can represent a greater distance to the target object than a shorter indicator. As the distance to the target object lessens, the length of the indicator will correspondingly reduce. In one embodiment, the length of the arrow can correspond in a relative fashion to a distance to the target object. For example, if the distance to the target object is in a range of approximately 1-3 meters, the length of the arrow can be approximately 1 centimeter. In alternate embodiments, any suitable length or measurement correspondence can be used, if desired. For example, if the distance is greater than 10 meters, the length of the arrow might be at a maximum length on the display. As the distance reduces, the length decreases either relatively, or incrementally.

Also, the width of the indicator can also be used to represent a property such as distance. For example, the farther the distance to or from the target object, the thinner the width of the indicator. As the target object gets closer and the distance lessens, the width of the indicator increases. In this embodiment, the length of the arrow can change or remain constant. The distance parameter might also be represented by the color of the indicator, where the color changes to correspond to changes in distance.

In one embodiment, the style of the indicator can be configured to vary to correspond to an estimated reliability of the location information of a signal quality from the target object. For example, estimation can be made as to the reliability of the direction and distance estimates. Where the reliability is high, the indicator can be presented with a “strong” style. Where the reliability of the information is low, the indicator can have a “weak” presentation. In one embodiment, where the target object is tagged with a transmitting device, the signal quality of the target object can be represented by the weight or type of indicator. For example, mobile communication devices include transmitting devices for which the signal quality can be determined. Also, certain types of “tags” exist that can emit a signal, the strength of which can be monitored. In accordance with the aspects of the disclosed embodiments, when the signal emitted by the target object is strong, the indicator 200 can be presented in a manner is more bold than when the signal is weak. For example, a strong signal can be represented by a dark line. When the signal is weaker, or there is interference in the radio environment, and the system cannot securely lock onto or determine the signal, the indicator might have a lighter relative appearance, or be presented as a dashed or semi-transparent (watermark) line or appearance. In one embodiment, the indicator 200 might appear to fade or flash when the signal strength is weak, or the distance is far, compared to a steady presentation when the signal is strong or the target object is closer.

Referring to FIGS. 2B-2D, some examples of the correspondence of properties of an indicator to location data or information are illustrated. In FIG. 2B, arrow 200 illustrates a relative distance to a target object. The arrow 200 has a width 202 and a length 204. In this example, arrow 200 represents a distance to the target object that is greater than 50 meters. Arrow 210 represents a distance that is in the range of approximately 10-50 meters. As shown in FIG. 2B, arrow 210 has a width 212 that is somewhat thicker than the width 202 of arrow 200. The length 214 of arrow 210 is somewhat shorter than the length 204 of arrow 200. Arrow 220 represents a distance that is in the range of approximately 3-10 meters. The width 222 and length 224 of arrow 220 are different than those of arrows 200 and 210 to indicate the relative changes and distances. Arrow 230 represents a distance that is less than approximately 3 meters. The width 232 is greater relative to the widths of arrows 200-220, and length 234 is less than the lengths of arrows 200-220 to illustrate the relative distance.

In FIG. 2C, arrows 240-260 show how obstacles in the directional path can be illustrated. Arrow 240 has a curved shape 246. As the distance range decreases for each of arrows 250 and 260, the widths and lengths change correspondingly, while maintain a curved shape.

In FIG. 2D, the signal strength properties, as represented on indicators 280 and 290 are shown. Arrow 280 is formed of a broken line or style 288, shown as dashes, to indicate a weak or weaker signal, compared to the style 208 of arrow 200. In alternate embodiments, any suitable style can be used to represent signal strength, including for example, a dotted line, a mix of dashes and dots, a dimmed line, a transparent line or a size of the line. Arrow 280 also has a curved shape 286 to indicate one or more obstacles in the path to the target object. Arrow 290 also has a dashed style 298 to indicate weak signal strength relative to the signal strength indication 208 of arrow 200.

In one embodiment, certain characteristics of the indicator, such as for example, a color, brightness or contrast of each arrow shown in FIGS. 2B-2D, can be varied to illustrate relative distance. Referring to FIG. 2C, where arrow 240 corresponds to a distance greater than 50 meters, the color or contrast 243 is different from the color or contrast 253 of arrow 250, where the represented distance is less than that of arrow 240. For example, the contrast 243 of line 240 appears darker than contrast 253 of line 250 or contrast 213 of line 210. Similarly, the contrast or color 263 of line 260 can be different from lines 240 and 250 to represent the different distance corresponding line 260.

In one embodiment, the correspondence of properties of the indicator to categories of location information can be assigned or set by the user. In alternate embodiments, the correspondence of properties of the indicator to the categories of location information can be predetermined and set in any suitable manner, and can also be based relative to the particular indicator being used. The scope of the disclosed embodiments is not limited by the type or form of indicator being used, the properties of the indicator or the correspondence of indicator properties to categories of location information.

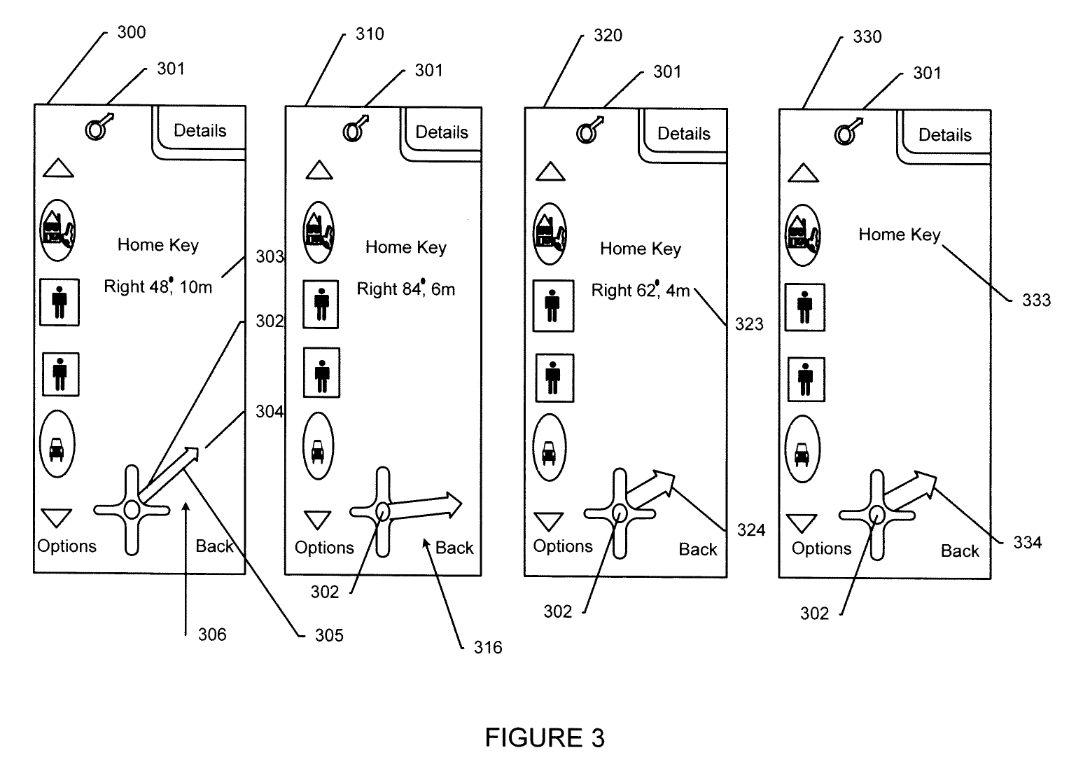

FIG. 3 illustrates on example of the application of the disclosed embodiments on a user interface of a suitable device. Screens 300-330 represent examples of a user interface 301 of a device (not shown), such as for example, a mobile communication device. Each screen 300-330 represents the process of the changes in the indicator 302 according to changes in distance, obstacle and signal strength.

In screen 300, the indicator 302, which in this example is an arrow, indicates the relative direction 304 to the target object. As shown in each of screens 300-330, the position or direction heading of the indicator 302, changes to each of directions 304-324 as the position of the device (not shown) changes relative to the target object. In one embodiment, the user interface 301 can also be configured to present textual information that indicates position and distance. As shown in screens 300-320, the position and distance is presented as 303, 313, 323 and 333, respectively.

The width and length of the indicator 302 will vary according to the relative distance from the target object. The width 305 and length 306 of indicator 302 in screen 300 is different relative to the width 315 and length 316 of the indicator 302 in screen 310. As noted from the textual indications 303 and 313, the distance is screen 300 is greater relative to the distance shown in screen 310.

Referring again to FIG. 1, each of the location information detection module 136, the coding module 138, and indicator module 140 are configured to receive and transmit information to and between each other and each of the other devices, module and components of the system 100. Each module can include its own processor(s) and computer readable storage medium for carrying out and executing the processes described herein.

The application process controller 132 can be configured to interface with the applications module 180 and execute applications processes with respects to the other modules of the system 100. In one embodiment the applications module 180 is configured to interface with applications that are stored either locally to or remote from the system 100 and/or web-based applications. The applications module 180 can include any one of a variety of applications that may be installed, configured or accessible by the system 100, such as for example, office, business, media players and multimedia applications, web browsers, global positioning applications, navigation and position systems and locations and map applications. In alternate embodiments, the applications module 180 can include any suitable application that can be used by or utilized in the processes described herein.

The communication module 134 shown in FIG. 1 is generally configured to allow the device to receive and send communications and messages, such as location and position data, navigation information, text messages, chat messages, multimedia messages, video and email, for example. The communications module 134 is also configured to receive information, data and communications from other devices and systems or networks, such as for example, the Internet. In one embodiment, the communications module 134 is configured to interface with, and establish communications connections with other services and applications using the Internet.

In one embodiment, the applications module 180 can also include a voice recognition system that includes a text-to-speech module that allows the user to receive and input voice commands, prompts and instructions, through a suitable audio input device.

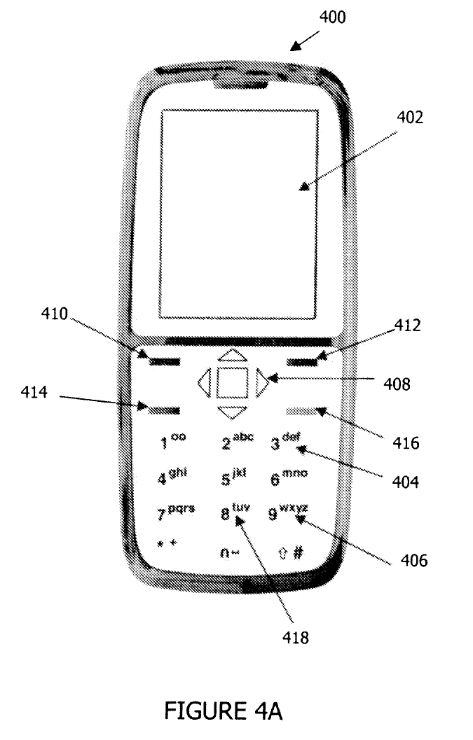

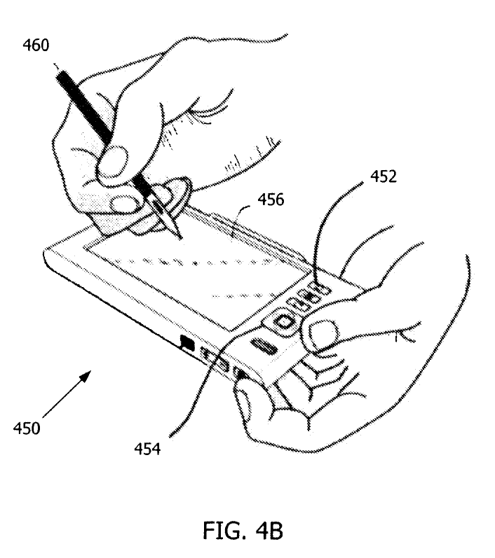

Some examples of devices on which aspects of the disclosed embodiments can be practiced are illustrated with respect to FIGS. 4A-4B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

FIG. 4A illustrates one example of a device 400 that can be used to practice aspects of the disclosed embodiments. As shown in FIG. 4A, in one embodiment, the device 400 has a display area 402 and a touch sensitive area 404. The user interface of the disclosed embodiments can be implemented on or in a device that includes a touch sensitive area, touch screen display, proximity screen device or other graphical user interface.

In one embodiment, the touch sensitive area 404 can include keypad 406 as an input device. The keypad 406, in the form of soft keys, may include any suitable user input functions such as, for example, a multi-function/scroll key 410, soft keys 410, 412, call key 414, end key 416 and alphanumeric keys 418. The keypad 406 can also be in the form of the keypad 100 shown in FIG. 1. In one embodiment, referring to FIG. 4B., the touch screen area 456 of device 450 can also present secondary functions, other than a keypad, using changing graphics.

In one embodiment, the display 402 is integral to the device 400. In alternate embodiments the display may be a peripheral display connected or coupled to the device 400. As shown in FIG. 4B, in one embodiment, a pointing device, such as for example, a stylus 460, pen or simply the user's finger may be used with the display 456. In alternate embodiments any suitable pointing device may be used. In other alternate embodiments, the display may be any suitable display, such as for example a flat display 456 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

In one embodiment, the device 400 can include an image capture device such as a camera (not shown) as a further input device. The device 400 may also include other suitable features such as, for example a loud speaker, tactile feedback devices or connectivity port. The mobile communications device may have a processor or other suitable computer program product (not shown) connected or coupled to the display for processing user inputs and displaying information on the display 402 and touch sensitive area 404. A computer readable storage device, such as a memory (not shown) may be connected to the processor for storing any suitable information, data, settings and/or applications associated with the mobile communications device 400.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 100 of FIG. 1 may be for example, a personal digital assistant (PDA) style device 450 illustrated in FIG. 4B. The personal digital assistant 450 may have a keypad 452, cursor control 454, a touch screen display 456, and a pointing device 460 for use on the touch screen display 456. In one embodiment, the touch screen display 456 can include the QWERTY keypad as discussed herein. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display 114 shown in FIG. 1, and supported electronics such as the processor and memory of FIG. 4A. In one embodiment, these devices will be Internet enabled and include GPS and map capabilities and functions.

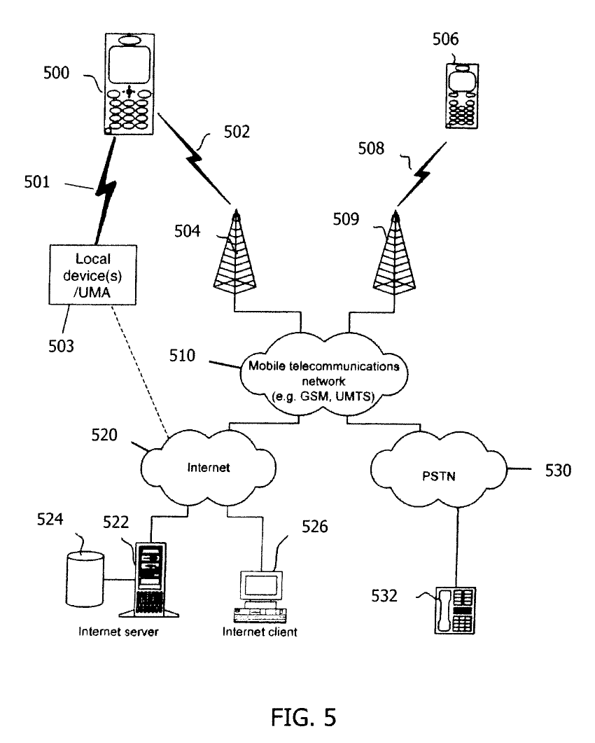

In the embodiment where the device 400 comprises a mobile communications device, the device can be adapted for communication in a telecommunication system, such as that shown in FIG. 5. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 500 and other devices, such as another mobile terminal 506, a line telephone 532, a personal computer (Internet client) 526 and/or an internet server 522.

It is to be noted that for different embodiments of the mobile device or terminal 500, and in different situations, some of the telecommunications services indicated above may or may not be available. The aspects of the disclosed embodiments are not limited to any particular set of services or communication, protocol or language in this respect.

The mobile terminals 500, 506 may be connected to a mobile telecommunications network 510 through radio frequency (RF) links 502, 508 via base stations 504, 509. The mobile telecommunications network 510 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 510 may be operatively connected to a wide-area network 520, which may be the Internet or a part thereof. An Internet server 522 has data storage 524 and is connected to the wide area network 520. The server 522 may host a worldwide web/wireless application protocol server capable of serving worldwide web/wireless application protocol content to the mobile terminal 500. The mobile terminal 500 can also be coupled to the Internet 520. In one embodiment, the mobile terminal 500 can be coupled to the Internet 520 via a wired or wireless link, such as a Universal Serial Bus (USB) or Bluetooth™ connection, for example.

A public switched telephone network (PSTN) 530 may be connected to the mobile telecommunications network 510 in a familiar manner. Various telephone terminals, including the stationary telephone 532, may be connected to the public switched telephone network 530.

The mobile terminal 500 is also capable of communicating locally via a local link 501 to one or more local devices 503. The local links 501 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 503 can, for example, be various sensors that can communicate measurement values or other signals to the mobile terminal 500 over the local link 501. The above examples are not intended to be limiting, and any suitable type of link or short range communication protocol may be utilized. The local devices 503 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 500 may thus have multi-radio capability for connecting wirelessly using mobile communications network 510, wireless local area network or both. Communication with the mobile telecommunications network 510 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the process modules 122 of FIG. 1 include communication module 134 that is configured to interact with, and communicate with, the system described with respect to FIG. 5.

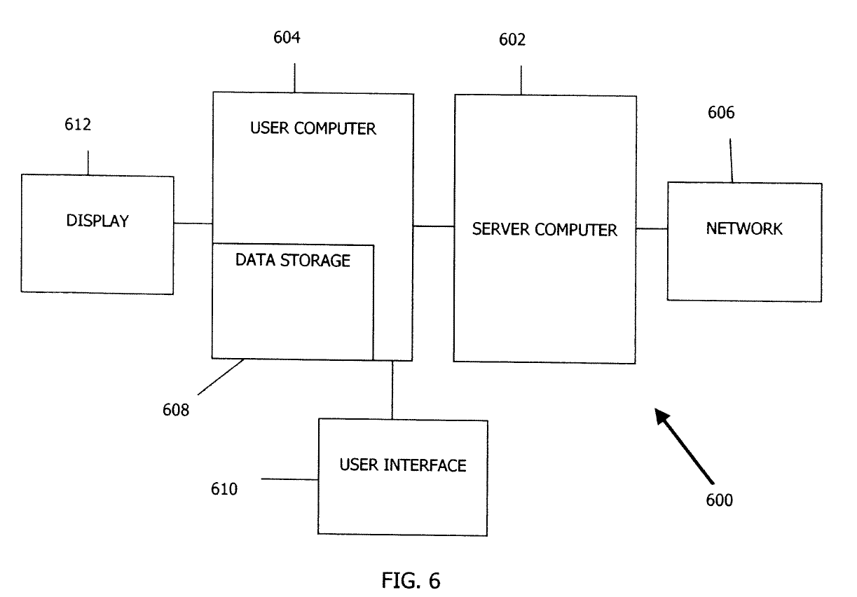

The disclosed embodiments may also include software and computer programs incorporating the process steps and instructions described above. In one embodiment, the programs incorporating the process steps described herein can be stored on or in a computer program product and executed in one or more computers. FIG. 6 is a block diagram of one embodiment of a typical apparatus 600 incorporating features that may be used to practice aspects of the invention. The apparatus 600 can include computer readable program code means stored on a computer readable storage medium for carrying out and executing the process steps described herein. In one embodiment the computer readable program code is stored in a memory of the device. In alternate embodiments the computer readable program code can be stored in memory or memory medium that is external to, or remote from, the apparatus 600. The memory can be direct coupled or wireless coupled to the apparatus 600. As shown, a computer system 602 may be linked to another computer system 604, such that the computers 602 and 604 are capable of sending information to each other and receiving information from each other. In one embodiment, computer system 602 could include a server computer adapted to communicate with a network 606. Alternatively, where only one computer system is used, such as computer 604, computer 604 will be configured to communicate with and interact with the network 606. Computer systems 602 and 604 can be linked together in any conventional manner including, for example, a modem, wireless, hard wire connection, or fiber optic link. Generally, information can be made available to both computer systems 602 and 604 using a communication protocol typically sent over a communication channel or other suitable connection or line, communication channel or link. In one embodiment, the communication channel comprises a suitable broad-band communication channel. Computers 602 and 604 are generally adapted to utilize program storage devices embodying machine-readable program source code, which is adapted to cause the computers 602 and 604 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor for executing stored programs. Computer 602 may include a data storage device 608 on its program storage device for the storage of information and data. The computer program or software incorporating the processes and method steps incorporating aspects of the disclosed embodiments may be stored in one or more computers 602 and 604 on an otherwise conventional program storage device. In one embodiment, computers 602 and 604 may include a user interface 610, and/or a display interface 612 from which aspects of the invention can be accessed. The user interface 610 and the display interface 612, which in one embodiment can comprise a single interface, can be adapted to allow the input of queries and commands to the system, as well as present the results of the commands and queries, as described with reference to FIG. 1, for example.

The aspects of the disclosed embodiments provide for coding location data to or for a target object such as distance, direction, signal quality and obstacle information into or onto a single, property changing indicator, such as an arrow. The farther the target object from the user device, the longer and thinner the arrow. The arrow color can also change relative to the distance. If the signal quality, or the reliability of the direction and distance estimate is low, the style of the arrow can change, to for example a dotted line, or the color or contrast can become faint. Obstacles can be reflected by adding one or more curves to the line of the arrow, representing that the user has to go around something in order to reach the target object. The aspects of the disclosed embodiments present a simple and intuitive way of location information presentation, since the user interface will only include one moving object and one focus point. The color and shape transition representing different indicator (and location status) is stepless using vector graphics.

The user interface features are implemented based on the output of the distance and direction, which in one embodiment can be implemented by a suitable direction and distance algorithm. The algorithm can be set to keep track of the direction and distance of the specific wireless device in proximity. In addition to direction and distance, in one embodiment, the algorithm can estimate a reliability of the direction and distance estimates. For example, variables such as direction, distance and reliability can be used to determine which indicator to be presented to the user.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
identifying location information for a target object in a mobile device;
coding the identified location information onto a graphical indicator in the mobile device; and,
presenting the graphical indicator on a user interface of the mobile device, wherein the indicator provides direction, distance, obstacle and signal information corresponding to the target object to a user of the mobile device.

2. The method of claim 1 further comprising that the direction, distance, obstacle and signal information correspond to variable properties of the indicator, and the variable properties of the indicator comprise, a length, width, color, brightness and style of the indicator, and wherein the device is configured to code the location information to each of the variable properties of the indicator.

3. The method of claim 3 further comprising that distance information to the target object corresponds to a length, width and color of the indicator, obstacle information between the mobile device and the target object corresponds to a shape of the indicator, and signal strength information corresponds to a style of the indicator.

4. The method of claim 3 wherein the device is configured to present an indicator that is longer and thinner for a greater distance to the target object relative to a shorter distance to the target object.

5. The method of claim 3 wherein the device is configured to present an indicator having a curved shape when at least one obstacle exists in a path between the mobile device and the target object.

6. The method of claim 3 wherein the device is configured to present a strong indicator on the user interface when the signal quality is high and a weak indicator when the signal quality is low.

7. The method of claim 3 wherein the indicator comprises an arrow.

8. The method of claim 2 wherein the device is configured to change each of the variable properties on the user interface corresponding to updated location information to the target object that is determined as a position of the mobile device changes or a position of the target object changes.

9. The method of claim 8 wherein the target object is a location, a person, a mobile communication device, a service or a tagged object.

10. An apparatus comprising:
an information input device;
a display device; and
at least one processor, the at least one processor configured to:
identify location information for a target object from location data in the information input device;
code the identified location information onto a graphical indicator; and,
present the graphical indicator on the display device, wherein the indicator provides direction, distance, obstacle and signal information of the target object relative to the apparatus.

11. The apparatus of claim 10 wherein the identified location information coded by the processor onto the indicator is direction, distance, obstacle and signal information corresponding to variable properties of the indicator.

12. The apparatus of claim 11 wherein the variable properties of the indicator comprise a length, width, color, brightness and style or the indicator.

13. The apparatus of claim 11 wherein the distance information to the target object corresponds to a length, width and color of the indicator, obstacle information between the apparatus and the target object corresponds to a shape of the indicator, and signal strength information corresponds to a style of the indicator.

14. The apparatus of claim 11 wherein the processor is configured to present an indicator that is longer and thinner for a distance that is greater to the target object relative to a distance that is shorter to the target object.

15. The apparatus of claim 11 wherein the processor is configured to present an indicator having a curved shape when at least one obstacle exists in a path between the mobile device and the target object.

16. The apparatus of claim 11 wherein the processor is configured to present a strong indicator on the display unit when the signal quality is high and a weak indicator when the signal quality is low.

17. The apparatus of claim 11 wherein the processor is configured to change each of the variable properties on the display corresponding to updated location information to the target object that is determined as a position of the apparatus changes or a position of the target object changes.

18. A computer program product comprising a computer readable storage medium configured to execute the method according to claim 1 when implemented on a device including at least one processor.

19. A method comprising:
identifying location information for a target object relative to a mobile device, in the mobile device;
coding the location information to respective variable properties of an arrow indicator in the mobile device, where a length and size of the indicator corresponds to a distance to the target object, a shape of the indicator corresponds to any obstacles in a path to the target object and a style of the indicator corresponds to a signal quality of the identified location information;
presenting the indicator on a display of the mobile device; and
updating each variable property of the indicator on the mobile device to reflect updated location information as the mobile device determines the updated location information relative to detected changes in position of the target object or the mobile device.

20. The method of claim 19 further comprising dynamically changing a direction position of the indicator on the display of the device to correspond to changes in a direction of the target object relative to the device and changing a length and width of the indicator to reflect distance changes to the target object from the device.
